(19) United States
(12) Patent Application Publication
(10) Pub. No.: US 2023/0230116 A1
(43) Pub. Date: Jul. 20, 2023

(54) METHOD AND ANALYSIS DEVICE FOR TRACKING MARKET INDEX AND UNMIXING HYPERSPECTRAL IMAGE USING MODIFIED ITERATIVE HARD THRESHOLDING FOR NONNEGATIVE SPARSE RECOVERY UNDER SUM-TO-ONE

(71) Applicant: City University of Hong Kong, Hong Kong (HK)

(72) Inventors: Xiaopeng LI, Shenzhen (CN); Chi Sing LEUNG, Hong Kong (HK); Hing Cheung SO, Hong Kong (HK)

(21) Appl. No.: 17/575,652

(22) Filed: Jan. 14, 2022

(51) Int. Cl. G06Q 30/02; G06Q 40/06; G06F 17/18; G06F 17/16

(52) U.S. Cl. CPC G06Q 30/0206; G06Q 40/06; G06F 17/18; G06F 17/16

(57) ABSTRACT

A computer-implemented method for simulating a market index is provided. The method includes: receiving object data from a data source; receiving control data from an input operation applied to the analysis server; identifying one or more first values and one or more second values from the object data, and identifying a first parameter, a second parameter and a third parameter from the control data; inputting the first values, the second values, the first parameter, the second parameter and the third parameter into an executed analysis model; and obtaining an optimized weight vector corresponding to the component stocks from the analysis model, so as to simulate the market index by the weight vector and the prices of the component stocks, wherein the weight vector comprising weight percentages respectively corresponding to the component stocks, and the sum of the weight percentages is equal to one.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to applications using the Nonnegative Sparse Recovery under Sum-to-One (NSR-SO), and in particular, to analytical techniques for tracking market index and unmixing hyperspectral image using the provided Modified Iterative Hard Thresholding (MIHT) for NSR-SO.

### BACKGROUND OF THE INVENTION

Nonnegative sparse recovery under the sum-to-one constraint is a special linear regression problem where the solution is required to simultaneously satisfy sparsity, nonnegativity and sum-to-one. It has been the core problems of two applications, namely (sparse) index tracking and hyperspectral image unmixing. Existing algorithms for the nonconvex constrained linear regression mainly utilize the penalty function method to convert the sparsity constraint into a regularization term, and then substitute [symbol] -norm by its approximation or [symbol] -norm. Thereby, the sparsity is determined via tuning the associated regularization parameter, which is extremely time-consuming in practice.

Therefore, there is a need for reducing the computational complexity of NSR-SO without adversely affecting the accuracy performance, so to achieve a higher efficiency of the operations (e.g., market index tracking, hyperspectral image unmixing, etc.) using the NSR-SO.

### SUMMARY OF THE INVENTION

In accordance to various embodiments of the present invention, projected gradient descent is used to directly deal with the nonconvex constrained linear regression problem without involving penalty parameters and approximate function. In addition, the [symbol] -norm is restricted by an upper bound, and hence the proposed algorithm is able to accurately control the sparsity via the upper bound. The developed approach is named Modified Iterative Hard Thresholding (MIHT). MIHT comprises two simple steps, namely gradient descent and nonconvex projection.

In accordance to one aspect of the present invention, a computer-implemented method for simulating a market index by determining ratios of one or more component stocks of the market index by an analysis device is provided. The method includes: receiving, by a processor of the analysis device, object data from a data source; and receiving, by the processor, control data from an input operation applied to the analysis server. The method further includes: identifying, by the processor, one or more first values and one or more second values from the object data; and identifying a first parameter, a second parameter and a third parameter from the control data. The first values are one or more index values of the market index within a period, and the second values are prices of the component stocks corresponding to the index values. The first parameter is a desired/set total number of the component stocks (or assets) that are selected to track the market index, the second parameter is a a chosen/set step-size in gradient descent, and the third parameter is a set maximum total number of one or more optimization iterations. The method further includes: inputting, by the processor, the first values, the second values, the first parameter, the second parameter and the third parameter into an executed analysis model. Then, the processor generates an optimized weight vector corresponding to the component stocks from the analysis model, so as to simulate the market index by the weight vector and the prices of the component stocks, wherein the weight vector comprising weight percentages respectively corresponding to the component stocks, and sum of the weight percentages is equal to one.

In accordance to another aspect of the present invention, a computer-implemented method for unmixing a hyperspectral image by determining a fractional abundance matrix corresponding to a spectral library by an analysis device is provided. The method includes: receiving, by a processor of the analysis device, object data from a data source; and receiving, by the processor, control data from an input operation applied to the analysis server. The method further includes: identifying, by the processor, a measured pixel spectrum of a hyperspectral image and a spectral library having one or more spectral signatures of one or more materials captured in the hyperspectral image from the object data; and identifying a first parameter, a second parameter and a third parameter from the control data. The first parameter is a set total number of the materials in the hyperspectral image, the second parameter is a chosen/set step-size in gradient descent, and the third parameter is a set maximum total number of optimization iterations. The method further includes: inputting, by the processor, the measured pixel spectrum, the spectral library, the first parameter, the second parameter and the third parameter into an executed analysis model. Then, the processor generates a fractional abundance matrix corresponding to the spectral library, so as to simulate the hyperspectral image by the fractional abundance matrix and the spectral library, wherein the fractional abundance matrix comprising weight percentages respectively corresponding to spectral signatures of pixels in the hyperspectral image, and sum of the weight percentages is equal to one.

In accordance to a further aspect of the present invention, an analysis device is provided, and the analysis device comprises a processor configured to execute machine instructions to implement the methods described above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A depicts a block diagram illustrating an analysis device in accordance with one embodiment of the present invention;

FIG. 1B depicts an illustration of a projection operator;

FIG. 2 depicts a flowchart of a market index tracking method implemented by the analysis device in accordance with one embodiment of the present invention;

FIG. 3 depicts a schematic diagram illustrating data flows corresponding to an analysis model for tracking market index;

FIG. 4 depicts a flowchart of the analysis model for tracking market index;

FIG. 5 depicts a flowchart of an optimization iteration performed by the analysis model for tracking market index;

FIG. 6 depicts a flowchart of a hyperspectral image unmixing method implemented by the analysis device in accordance with another embodiment of the present invention;

FIG. 7 depicts a schematic diagram illustrating data flows corresponding to an analysis model for unmixing hyperspectral image;

FIG. 8 depicts a flowchart of the analysis model for unmixing hyperspectral image;

FIG. 9 depicts a flowchart of an optimization iteration performed by the analysis model for unmixing hyperspectral image;

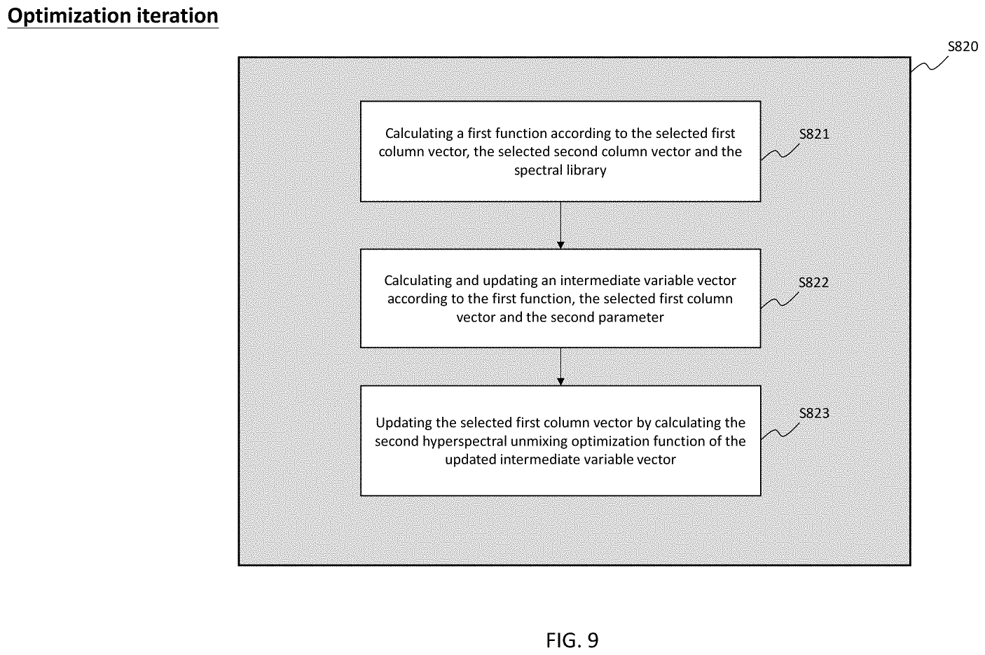

FIG. 10 depicts a schematic diagram of generating a colorization image according to an optimized fractional abundance matrix obtained by unmixing hyperspectral image; and

FIG. 11 depicts a schematic diagram of comparing the results of HIU of the provided MIHT for NSR-SO method with other algorithms.

### DETAILED DESCRIPTION

In the following description, methods and devices for simulating a market index, unmixing a hyperspectral image and the likes by using MINT for NSR-SO and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

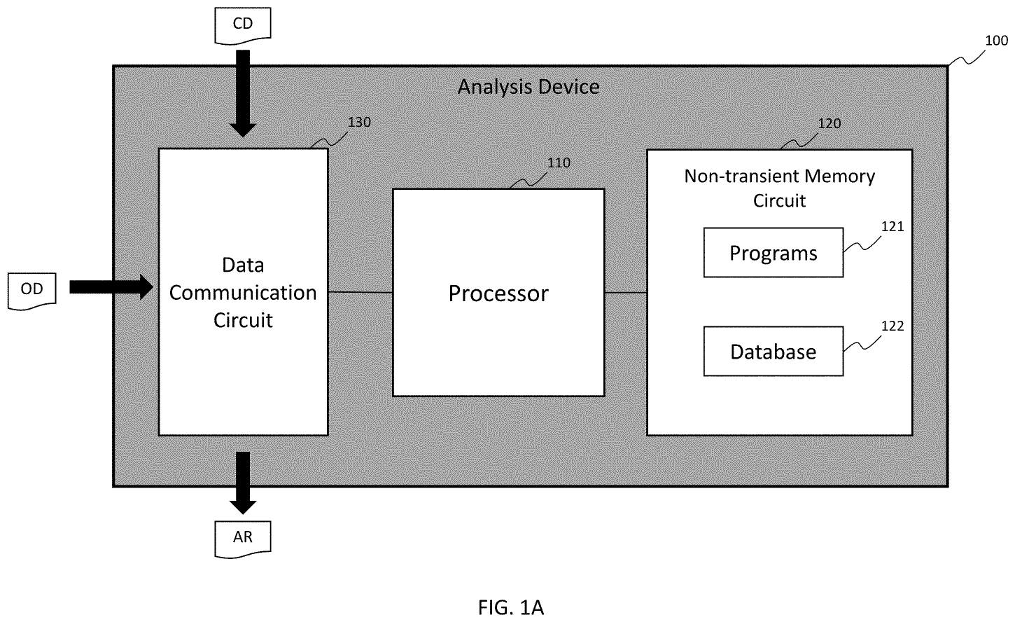

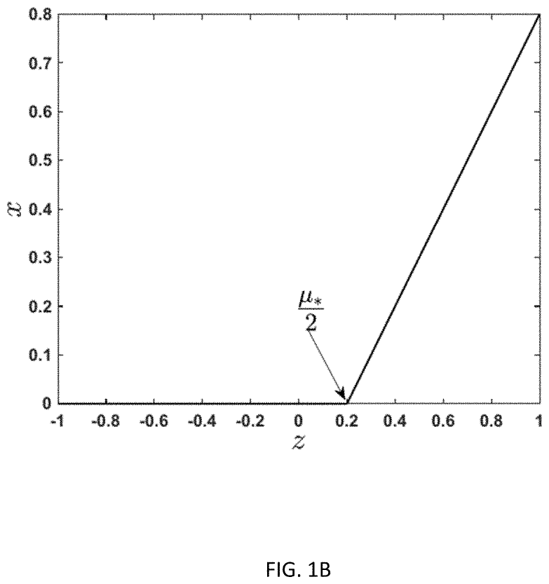

Referring to FIG. 1A, an analysis device 100 includes a processor 110, a non-transient memory circuit 120 and a data communication circuit 130.

The non-transient memory circuit 120 is configured to store programs 121 (or machine instructions 121) and to host the database 122. The database 122 may be used to store object data OD, control data CD, and/or analysis result AR. The data communication circuit 130 is configured to establish the network connection(s) for receiving the object data OD and the control data CD, and the network connection(s) can be wired or wireless data communication connection(s). Furthermore, the data communication circuit 130 is configured to establish a further network connection for sending the analysis result AR. In a further embodiment, the control data CD can be received from an input operation applied to (an I/O device of) the analysis device. The processor 110 executes the machine instructions 121 to implement methods provided by the presented disclosure.

Consider a nonnegative sparse vector x∈ [symbol] ⁿ. NSR-SO refers to recovering x from an observed [symbol] ∈ [symbol] ^{m} based on a transformation matrix A∈ [symbol] ^{m×n}, formulated as:

$${min}_{x} f ( x ) := {‖ Ax - y ‖}_{2}^{2} , s . t . x \geq 0 , {‖ x ‖}_{0} \leq S , {1}^{T} x = 1 \qquad ( 1 )$$

where x≥0 denotes that all entries are nonnegative, ∥x∥₀ is the [symbol] ₀-norm of x, corresponding to the total number of nonzero entries, S>0 controls the sparsity of x. On the other hand, NSR-SO can be considered as a linear regression problem subject to nonnegativity, sparsity and sum-to-one constraints. Since the bounded to [symbol] -norm is intractable, most of the existing methods convert the sparsity [symbol] constraint into a regularization term, leading to:

$${min}_{x} {‖ Ax - y ‖}_{2}^{2} + λ {‖ x ‖}_{0} s . t . x \geq 0 , {1}^{T} x = 1 \qquad ( 2 )$$

where λ>0 is a penalty parameter to trade off the fitting error and sparsity. Unfortunately, [symbol] -norm minimization is an NP-hard problem, and hence some approximate functions are proposed to replace the [symbol] -norm. The [symbol] -norm is widely considered as the first alternative, but it cannot be employed in (2). This is because ∥x∥₁ is equal to 1 under x≥0 and 1^{T}x=1. Thereby, weighted [symbol] ₁-norm is exploited to solve (2):

$${min}_{x} {‖ Ax - y ‖}_{2}^{2} + λ {\sum }_{i = 1}^{n} {w}_{i} ‖ {x}_{i} ‖ s . t . x \geq 0 , {1}^{T} x = 1 \qquad ( 3 )$$

where w=[w₁, . . . , wₙ]^{T} is a weight vector.

Then, the augmented Lagrange method is adopted as the solver to handle (3). As (3) is a convex optimization problem, it is easy to seek the global optimal solution. Nevertheless, the weighted [symbol] -norm cannot guarantee the solution to be the sparsest, implying that there are lots of very small values rather than zeros in the solution.

On the other hand, a continuous and differentiable function is devised to replace [symbol] -norm, leading to:

$${min}_{x} {‖ Ax - y ‖}_{2}^{2} + λ {1}^{T} {ρ}_{p , ζ} ( x ) s . t . x \geq 0 , {1}^{T} x = 1 \qquad ( 4 )$$

where ρ_{p,μ}(x) is defined as:

$${ρ}_{p , ζ} ( x ) = \{ {ρ}_{p , μ} ( {x}_{i} ) \} = \{ \frac{log ( 1 + \vert {x}_{i} \vert / p )}{log ( 1 + ζ / p )} \} . \qquad ( 5 )$$

Then, the majorization-minimization approach is used to tackle the nonconvex (4).

It is worth noting that the mentioned methods require tuning λ to control the sparsity. In practice, it is time-consuming to select λ for attaining the desired sparsity.

In the embodiment, a projected gradient descent framework is utilized to deal with NSR-SO.

Consider a general constrained optimization problem:

$${min}_{x} h ( x ) , \\ s . t . x ∈ 𝒲 \qquad ( 6 )$$

where [symbol] is a constraint set. Then, projected gradient descent iteratively updates x as:

z^{t+1}=x^{t}−μ∇h(x^{t}),

xⁱ⁺¹= [symbol] (zⁱ⁺¹) (7)

where μ>0 is a step-size and [symbol] (z^{t+1}) is a projection operator, defined as:

$${min}_{x} {‖ {𝓏}^{t + 1} - x ‖}_{2}^{2} , \\ s . t . x ∈ 𝒲 , \qquad ( 8 )$$

That is, the aim of the projection is to search for a point x∈ [symbol] that has the shortest Euclidean distance to z^{t+1}. When [symbol] is a convex and closed set, the optimal x is unique.

Based on projected gradient descent, the proposed algorithm handles (1) via the following iterative procedure:

z^{t+1}=x^{t}−μA^{T}(Ax−y),

xⁱ⁺¹=P_{C}(z^{t+1}) (9)

where P_{C}(z^{t+1}) is:

$${min}_{x} {‖ {𝓏}^{t + 1} - x ‖}_{2}^{2} , \\ s . t . x \geq 0 , \\ {‖ x ‖}_{0} \leq S , \\ {1}^{T} x = 1 \qquad ( 10 )$$

It can be known that [symbol] is a nonconvex set due to the bounded [symbol] -norm. To find the solution to P_{C}(z^{t+1}), \hat{z}^{t+1} instead of z^{t+1} is used as the input of P_{C}(⋅) where \hat{z}^{t+1} contains all entries of z^{t+1}, but all entries are sorted in descending order. When \hat{z}^{t+1} is computed, it requires recording an index [symbol] that specifies how the elements of z^{t+1} are rearranged to obtain the sorted z^{t+1}. The t is the iteration number and z can be considered as an intermediate variable. P_{C}(z^{t+1}) is a projection operator and defined by (11) where [symbol] is the set which is composed by the three constraints. Then, \hat{x} is calculated first with s=1:

$${\hat{x}}_{i} = \{ \begin{matrix}{\hat{𝓏}}_{i}^{t + 1} - \frac{{μ}_{s}}{2} , if i ∈ [ 1 , s ] , \\ 0 , otherwise ,\end{matrix} \\ where : \qquad ( 11 )$$

$${μ}_{s} = \frac{2 ( {\sum }_{i = 1}^{s} {\hat{𝓏}}_{i}^{t + 1} - 1 )}{s} . \qquad ( 12 )$$

Subsequently, a condition that \hat{z}ₛ₊₁^{t+1}≤μₛ/2 would be checked. If all the conditions are met, \hat{x} is determined as found. Otherwise, s is increase and then compute μₛ until s=S or \hat{z}ₛ₊₁^{t+1}≤μₛ/2. After attaining \hat{x}, x can be computed via restoring the order of \hat{x} based on [symbol] . The projection operator is illustrated in FIG. 1B.

As illustrated by FIG. 1B, the projection operator sets zᵢ above μ_{*}/2 as zᵢ−μ_{*}/2, while the elements that are smaller than μ_{*}/2 are turned to zero. Hence, the crucial issue is on choosing the threshold. The approach to determine μ_{*}/2 is provided above and the result of the projection operator is an optimal solution under a nonconvex set would be proved correspondingly.

The provided method is named Modified Iterative Hard Thresholding (MIHT), and the process steps of MIHT are summarized in Algorithm 1 below.

Algorithm 1 MIHT for NSL-SO

```
Input: A, y, S, μ and Tₘₐₓ
Output: x^{t+1}
  Initialize: x = 0
  for t = 1, 2, . . . , Tₘₐₓ do
    Calculate ∇f(xⁱ) = 2A^{T}(Ax − y)
    Update z^{t+1} = x^{t} − μ∇f(xⁱ)
    Compute x^{t+1} = P_{c}(z^{t+1})
    Stop if stopping criterion is met.
  end for
```

The process steps terminate with t=Tₘₐₓ. On the other hand, when MIHT tends to converge, it can be terminated, and the criterion is:

$$\frac{{‖ {x}^{t + 1} - {x}^{t} ‖}_{2}^{2}}{S} \leq {10}^{- 8} . \qquad ( 13 )$$

MIHT only has two parameters to set, that is, the sparsity S and step-size μ. For S, it is set as the desired sparsity. The selection of μ is suggested to (0, α/L] with 0<α≤1, where L is the L-Lipschitz constant of ƒ(x). For ƒ(x)=∥Ax− [symbol] μ₂², L=σₘₐₓ where σₘₐₓ is the largest eigenvalue of A^{T}A. On the other hand, μ can be determined by backtracking line search in each iteration. Compared with the fixed μ, an adaptive μ is more advantageous.

Sparse Index Tracking

In an embodiment, for the application to spare index tracking (e.g., market index tracking), given a market index [symbol] ∈ [symbol] ^{m} that contains the historical information on the past m trading days (e.g., within a period). Then, A=[a₁, . . . , aₙ]∈ [symbol] ^{m×n} are defined as the daily returns of n assets/stocks in the past m trading days, where aₙ refers to the n^{th} asset. In addition, x=[x₁, . . . , xₙ]^{T}∈ [symbol] ^{N} denotes the weight vector where xₙ is the proportion/percentage (not larger than 1) assigned to the n^{th} stock. Sparse index tracking is to replicate the market index [symbol] by a few assets/stocks. Hence, it can be formulated as a linear regression optimization problem:

$${min}_{x} {‖ Ax - y ‖}_{2}^{2} s . t . x \geq 0 {x}^{T} 1 - 1 {‖ x ‖}_{0} \leq S \qquad ( 14 )$$

In sparse index tracking, the three constraints are significant. First, the nonnegativity constraint (i.e., x≥0) denotes that the weight vector is nonnegative, which can avoid short-selling that has the potential risk for infinite loss. Second, the sum-to-one constraint (i.e., x^{T}1=1) denotes that the sum of all entries of the weight vector is equal to one, which implies that xₙ is an accurate proportion/percentage. Then, the assets/stocks corresponding to the market index can be allocated according to x. Third, the sparse constraint (i.e., ∥x∥₀≤S), which denotes that the total number of nonzero entries (respectively corresponding to the selected assets/stocks for tracking/simulating the market index) of x is not larger than the set constraint S. ∥x∥₀ is equal to the total number of nonzero entries in x. S is a desired/set total number of the component stocks (or assets) that are selected to track the market index.

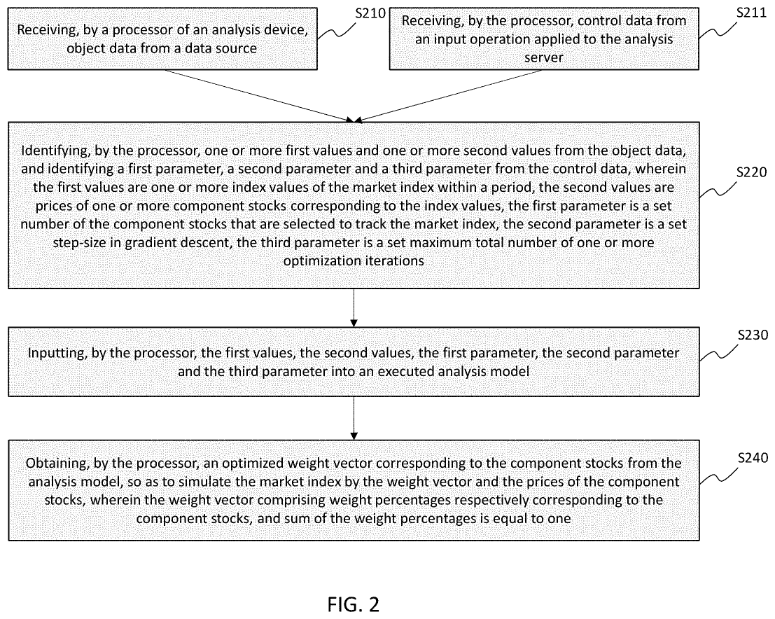

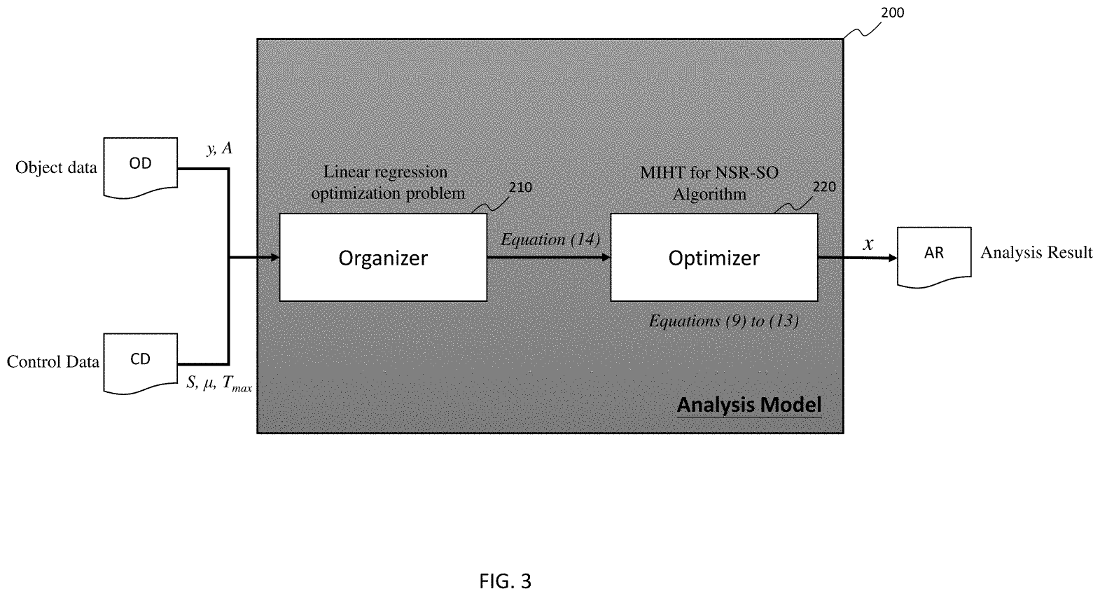

In the embodiment corresponding to the sparse index tracking, referring to FIG. 2 and FIG. 3, in step S210, the processor 110 of an analysis device 100 receives object data OD from a data source. The data source is, for example, a website or server which can provide financial information history related to market index(es).

Furthermore, in step S211, the processor 110 receives control data CD from an input operation applied to the analysis server.

Next, in step S220, the processor 110 identifies one or more first values and one or more second values from the object data, and identifying a first parameter, a second parameter and a third parameter from the control data, wherein the first values (y) are one or more index values of the market index within a period, the second values are prices of one or more component stocks (A) corresponding to the index values, the first parameter (S) is a desired/set total number of the component stocks (or assets) that are selected to track the market index, the second parameter (μ) is a chosen/set step-size in gradient descent, the third parameter (Tₘₐₓ) is a set maximum total number of one or more optimization iterations.

Specifically, regarding parameters, S is the desired number of assets that are selected to track the market index [symbol] . The μ is the step-size in gradient descent. The selection of μ is suggested to (0, α/L] with 0<α≤1 where L is the largest eigenvalue of A^{T}A. Note that (⋅)^{T} is transpose operator. Tₘₐₓ=500 is the preferred setting, but the invention is not limited hereto.

Next, in step S230, the processor 110 inputs the first values (y), the second values (A), the first parameter (S), the second parameter (μ) and the third parameter (Tₘₐₓ) into an executed analysis model 200. The analysis model 200 includes an organizer 210 and an optimizer 220.

Next, in step S240, the processor 110 obtains an optimized weight vector corresponding to the component stocks from the analysis model, so as to simulate the market index by the weight vector and the prices of the component stocks, wherein the weight vector comprising weight percentages respectively corresponding to the component stocks, and sum of the weight percentages is equal to one.

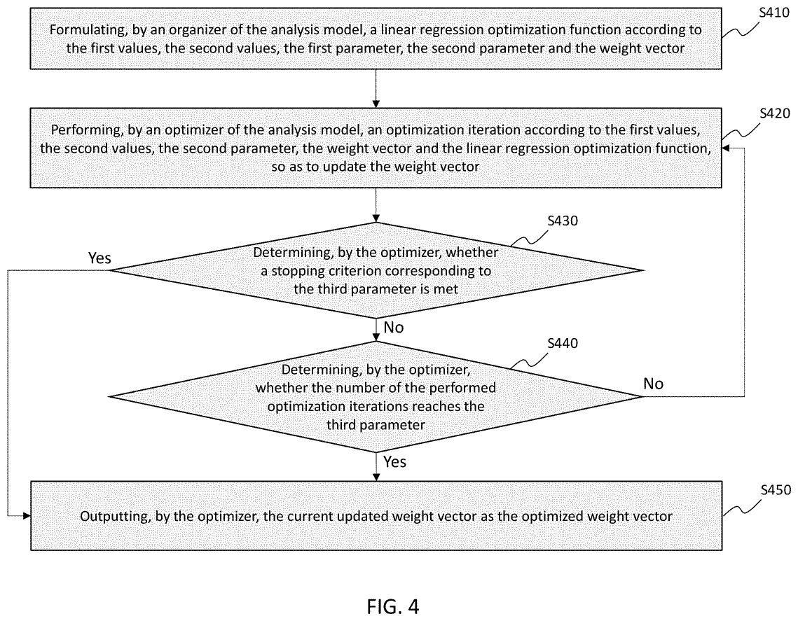

Referring to FIG. 3 and FIG. 4, in step S410, the organizer 210 formulates a linear regression optimization function according to the first values, the second values, the first parameter, the second parameter and the weight vector. The organizer 210 generates the linear regression optimization function according to equation (14).

Next, in step S420, the optimizer 220 performs one or more optimization iterations according to the algorithm 1 and equations (9) to (14) with the first values, the second values, the second parameter, the weight vector and the linear regression optimization function, so as to update the weight vector.

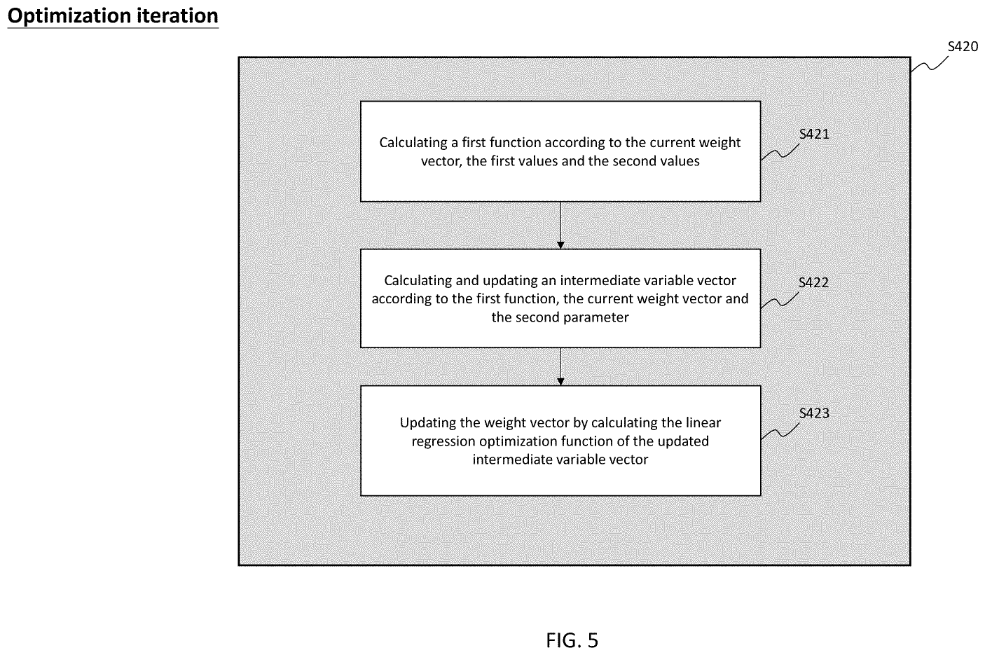

Referring to FIG. 5, in step S421, the optimizer 220 calculates a first function according to the current weight vector, the first values and the second values. The first function is calculated by the equation below (also see the algorithm 1):

∇ƒ(x^{t})=2A^{T}(Ax−y) (15)

wherein ∇ƒ(x^{t}) is the first function, A are the second values, x is the current weight vector, y is the first values, and t is current iteration number.

Next, in step S422, the optimizer 220 calculates and updates an intermediate variable vector according to the first function, the current weight vector and the second parameter. The intermediate variable vector is calculated by the equation below:

z^{t+1}=x^{t}−μ∇ƒ(x^{t}) (16)

wherein z^{t+1} is the updated intermediate variable vector, x is the current weight vector, μ is the second parameter, and t is current iteration number.

Next, in step S423, the optimizer 220 updates the weight vector by calculating the linear regression optimization function of the updated intermediate variable vector. The updated weight vector is calculated by the equation below:

x^{t+1}=P_{C}(z^{t+1}) (17)

wherein x^{t+1} is the updated weight vector, and P_{C}(z^{t+1}) is the projection optimization function of the updated intermediate variable vector, wherein P_{C}(z^{t+1}) is formulated by the projection optimization problem (i.e., equation 10).

After completing step S423, one optimization iteration is done, and “t” (current iteration number) is increased by 1 for next optimization iteration. Before proceeding to next optimization iteration, the processor 110 executing the analysis model 200 checks two conditions (e.g., steps S430 and S440). The orders of steps S430 and S440 can be exchanged.

In step S430, the optimizer 220 determines whether a stopping criterion corresponding to the third parameter is met. If the stopping criterion (e.g., the equation (13) corresponding to the algorithm 1) corresponding to the third parameter is not met, continues to step S440. If the stopping criterion corresponding to the third parameter is met, continues to step S450.

In step S440, the optimizer 220 determines whether the number of the performed optimization iterations reaches the third parameter. If the number of the performed optimization iterations reaches the third parameter, continues to step S450. If the number of the performed optimization iterations does not reach the third parameter, continues to step S420 (to perform next optimization iteration).

In step S450, the optimizer 220 outputs the current updated weight vector as the optimized weight vector. The optimized weight vector can be added by auxiliary information (e.g., the name of the market index, the component stocks, etc.) corresponding to the market index to generate and output the analysis result AR.

In a scenario, for example, assuming that the S&P 500 market index is tracked by 10 particular stocks among all the component stocks corresponding to S&P500 market index. Historical data of S&P500 (e.g., the object data) and the component stocks (and their history prices) are downloaded from a data source. Then, S should be set as 10. After tuning μ and Tₘₐₓ, the optimized output weight vector x in which only 10 entries corresponding to different stocks are not zero and the sum of the entries is equal to 1. If $100 is planned to be invested to S&P500, 100 multiplying the nonzero entries are each individual investment amount to each stock, such that the performance of these 10 stocks would be closed to the performance of the market index of S&P500.

Hyperspectral Image Unmixing

In another embodiment, consider that Y∈ [symbol] ^{m×p} is the observed hyperspectral image with m spectral bands and p pixels. In practice, the acquired hyperspectral data is a 3rd-order tensor, involving m matrices. The matrices are vectorized and arranged as Y. Besides, let A∈ [symbol] ^{m×n} denote a spectral library having n spectral signatures. Spectral signature is the variation of reflectance or emittance of a material with respect to wavelengths (i.e., reflectance/emittance as a function of wavelength). The hyperspectral image unmixing is to seek a linear combination of endmembers for Y from the spectral library A, formulated as:

Y=AX+N (18)

where X∈ [symbol] ^{n×p} is the fractional abundance matrix, and N∈ [symbol] ^{L×N} is the noise matrix. Generally, N is generated by the MATLAB built-in command of “Y=awgn(AX, SNR)”, wherein SNR is signal-to-noise ratio.

In practice, the fractional abundance matrix X is subject to three physical constraints, namely the nonnegativity, sum-to-one, and sparsity constraints. Since each entry denotes the weight of spectral signature in a pixel, X is nonnegative. Then, the sum-to-one property indicates that abundances give the fractional proportions or percentages, of the different spectral signatures in a pixel. Moreover, a pixel is likely to be sensitive for a few of the spectral signatures, hence the column of X is sparse, resulting in a sparse X. Therefore, the hyperspectral unmixing problem can be formulated as:

$${min}_{X} {‖ AX - Y ‖}_{P}^{2} s . t . X \geq 0 , {1}^{T} X = {1}^{T} , X is sparse . \qquad ( 19 )$$

Since each column of X is independent, (16) can be decomposed into p vector optimization problems:

$${min}_{x} {‖ {Ax}_{j} - {y}_{j} ‖}_{2}^{2} s . t . {x}_{j} \geq 0 , {1}^{T} {x}_{j} = 1 , {‖ {x}_{j} ‖}_{0} \leq S \qquad ( 20 )$$

where xⱼ and yⱼ are the j^{th} column (vector) of X and Y, respectively. Thereby, the provided method can be utilized to handle the hyperspectral unmixing problem. After all the column vectors xⱼ are optimized, the fractional abundance matrix X can be obtained by composing all the column vectors xⱼ together to form the optimized fractional abundance matrix X.

Hyperspectral Image Unmixing is a procedure that decomposes the measured pixel spectrum of hyperspectral data (Y) into a collection of constituent spectral signatures (A) and a set of corresponding fractional abundances (X).

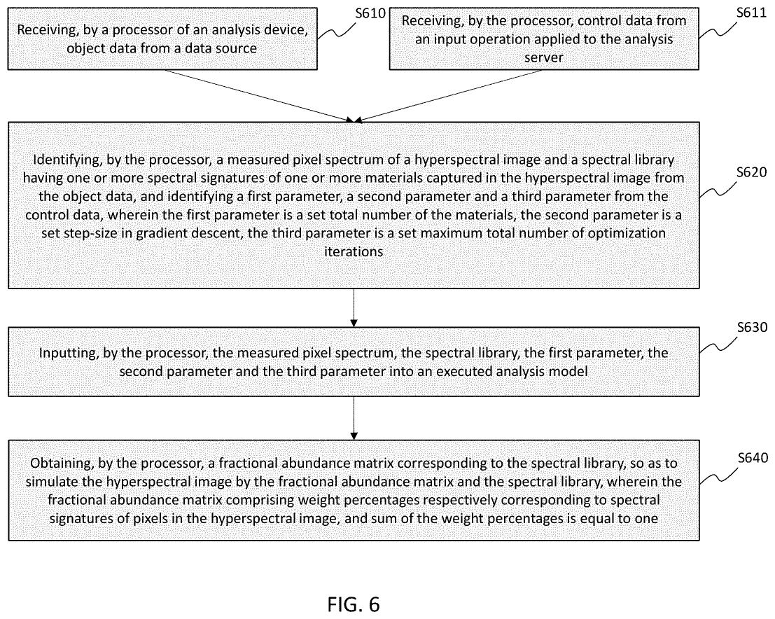

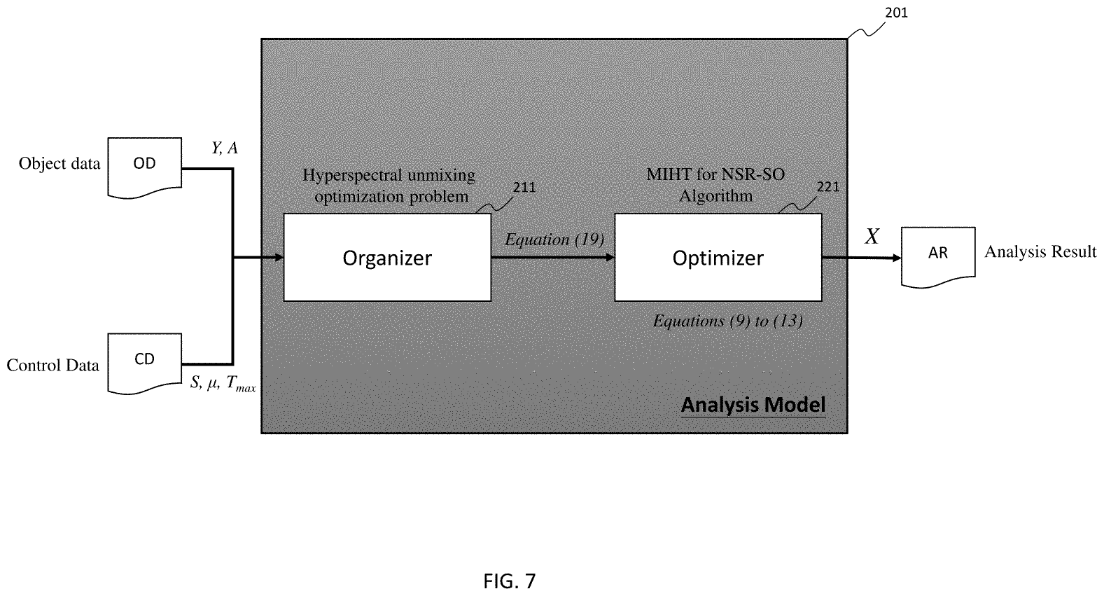

Referring to FIG. 6 and FIG. 7, in step S610, the processor 110 receives object data OD from a data source. The data source is, for example, a website or server which can provide remote sensing dataset including one or more hyperspectral images related to the satellite imagery.

Furthermore, in step S611, the processor 110 receives control data CD from an input operation applied to the analysis server 100.

Next, in step S620, the processor 110 identifies a measured pixel spectrum of a hyperspectral image and a spectral library having one or more spectral signatures of one or more materials captured in the hyperspectral image from the object data, and identifying a first parameter, a second parameter and a third parameter from the control data, wherein the first parameter (S) is a set total number of the materials, the second parameter (μ) is a chosen/set step-size in gradient descent, the third parameter (Tₘₐₓ) is a set maximum total number of optimization iterations.

Next, in step S630, the processor 110 inputs the measured pixel spectrum (Y), the spectral library (A), the first parameter (S), the second parameter (μ) and the third parameter (Tₘₐₓ) into an executed analysis model 210. The analysis model 210 includes an organizer 211 and an optimizer 221.

Next, in step S640, the processor 110 obtains a fractional abundance matrix corresponding to the spectral library, so as to simulate the hyperspectral image by the fractional abundance matrix (X) and the spectral library, wherein the fractional abundance matrix comprising weight percentages respectively corresponding to spectral signatures of pixels in the hyperspectral image, and the sum of the weight percentages is equal to one.

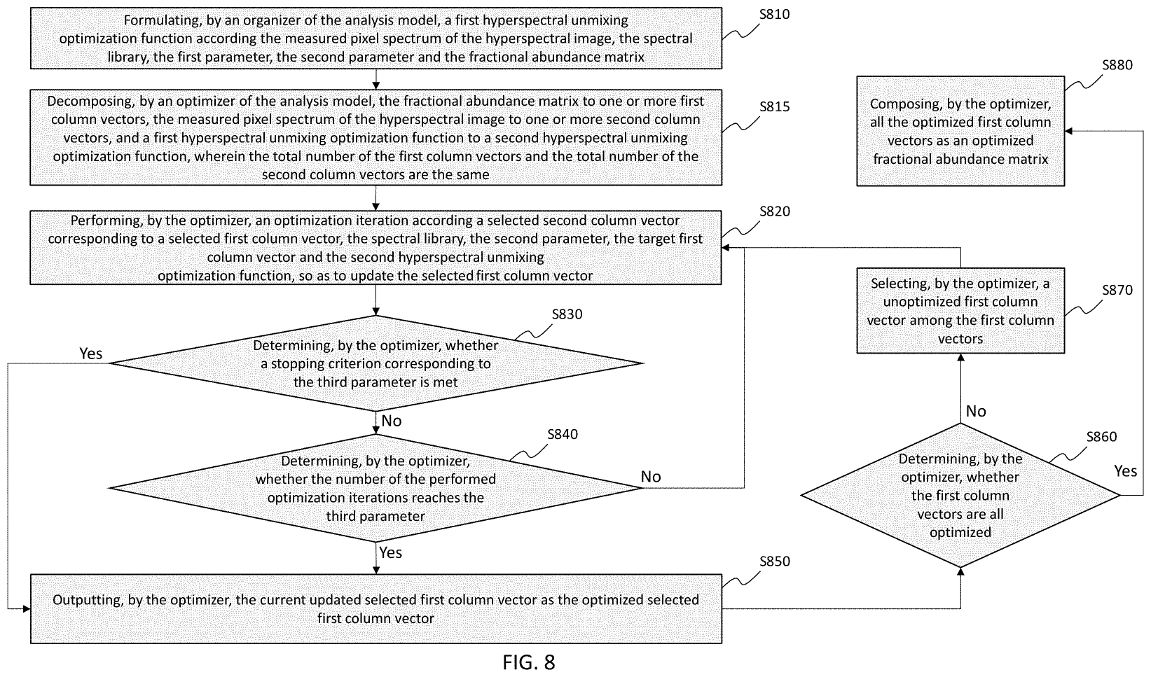

Referring to FIG. 7 and FIG. 8, in step S810, an organizer of the analysis model formulates a first hyperspectral unmixing optimization function according to the measured pixel spectrum of the hyperspectral image, the spectral library, the first parameter, the second parameter, and the fractional abundance matrix.

Next, in step S815, the optimizer 221 decomposes the fractional abundance matrix (X) to one or more first column vectors (xⱼ), the measured pixel spectrum (Y) of the hyperspectral image to one or more second column vectors (yⱼ), and a first hyperspectral unmixing optimization function to a second hyperspectral unmixing optimization function, wherein the total number of the first column vectors and the total number of the second column vectors are the same.

Next, in step S820, the optimizer 221 performs one or more optimization iterations according to the algorithm 1 and equations (9) to (14) and (19) with a selected second column vector corresponding to a selected first column vector, the spectral library, the second parameter, the target first column vector and the second hyperspectral unmixing optimization function, so as to update the selected first column vector.

Referring to FIG. 8, in step S821, the optimizer 221 calculates the first function according to the selected first column vector, the selected second column vector and the spectral library. The first function is calculated by the equation (15). Where, ∇ƒ(x^{t}) is the first function, A is the spectral library, x is the current selected first column vector, y is the selected second column vector, and t is current iteration number. The selected first column vector is one of xⱼ, where 1≤j≤q, and q is the total number of the column vectors. The selected second column vector is one of yⱼ.

Next, in step S822, the optimizer 221 calculates and updates an intermediate variable vector according to the first function, the selected first column vector and the second parameter. The intermediate variable vector is calculated by the equation (16). Where, z^{t+1} is the updated intermediate variable vector, x is the current selected first column vector, μ is the second parameter, and t is current iteration number.

Next, in step S823, the optimizer 221 updates the selected first column vector by calculating the second hyperspectral unmixing optimization function of the updated intermediate variable vector. The updated selected first column vector is calculated by the equation (17). Where, x^{t+1} is the updated selected first column vector, and P_{C}(z^{t+1}) is the second hyperspectral unmixing optimization function of the updated intermediate variable vector, wherein P_{C}(z^{t+1}) is formulated as the hyperspectral unmixing optimization problem (i.e., equation 20). Where, x≥0 denotes that the selected first column vector is nonnegative; x^{T}1=1 denotes that the sum of all entries of the selected first column vector is equal to one; S is the set total number of the materials in the hyperspectral image.

After completing step S823, one optimization iteration is done, and “t” (current iteration number) is increased by 1 for the next optimization iteration. Before proceeding to the next optimization iteration, the processor 110 executing the analysis model 201 check two conditions (e.g., steps S830 and S840). It should be mentioned that the orders of steps S830 and S840 can be exchanged.

In step S830, the optimizer 221 determines whether a stopping criterion corresponding to the third parameter is met. If the stopping criterion (e.g., the equation (13) corresponding to the algorithm 1) corresponding to the third parameter is not met, continues to step S840. If the stopping criterion corresponding to the third parameter is met, continues to step S850.

In step S840, the optimizer 221 determines whether the number of the performed optimization iterations reaches the third parameter. If the number of the performed optimization iterations reaches the third parameter, continues to step S850. If the number of the performed optimization iterations does not reach the third parameter, continues to step S820 (to perform the next optimization iteration).

In step S850, the optimizer outputs the current updated selected first column vector as the optimized selected first column vector.

Next, in step S860, the optimizer 221 determines whether the first column vectors are all optimized. If the first column vectors are all optimized, continues to step S880. If the first column vectors are not all optimized, continues to step S870.

In step S870, the optimizer 221 selects an unoptimized first column vector among the first column vectors (to be a new selected first column vector for next optimization iteration).

In step S880, the optimizer 221 composes all the optimized first column vectors as an optimized fractional abundance matrix (X). The optimized fractional abundance matrix (X) can be added by auxiliary information (e.g., the location/coordinates, the time, the date, etc.) corresponding to the hyperspectral image to generate and output the analysis result AR.

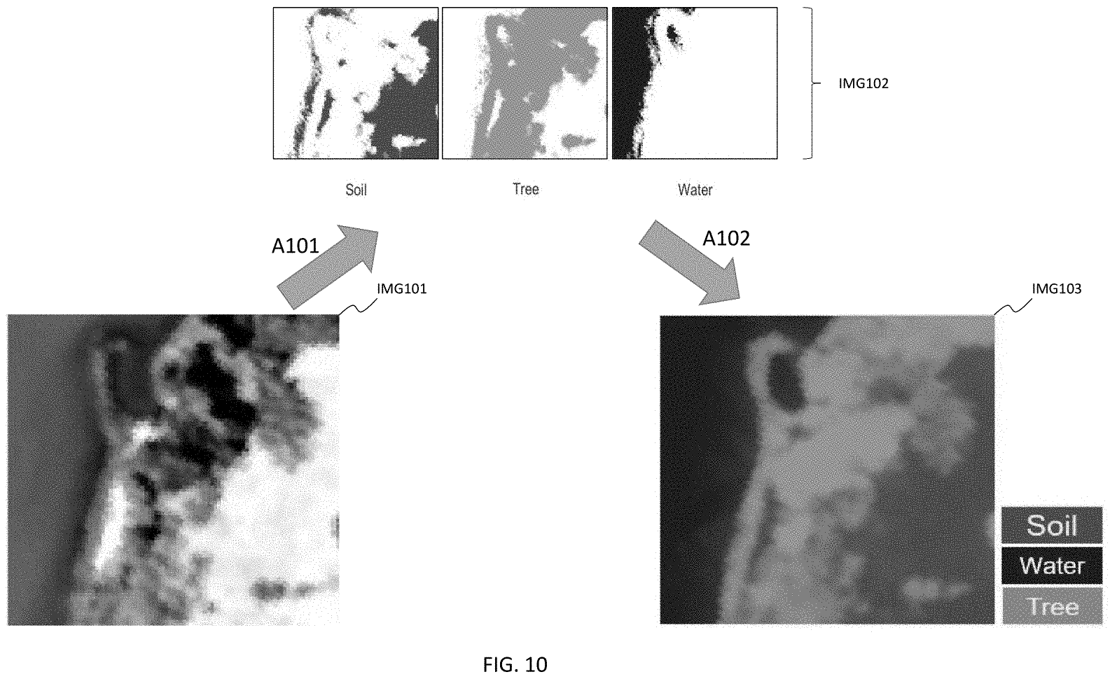

Through the optimized fractional abundance matrix, a colorization image can be generated accordingly. Materials/objects captured in the hyperspectral image can be colorized correspondingly based on the optimized fractional abundance matrix, spectral library and the predefined colors corresponding to the Materials/objects. For example, referring to FIG. 10, assuming that after obtaining the optimized fractional abundance matrix, materials “Soil”, “Water” and “Tree” is identified according to the spectral library and the hyperspectral image (e.g., IMG101), and then constructed as the image IMG102 (as indicated by arrow A101). Then, as indicated by arrow A102, a colorized image IMG103 is generated based on the IMG102 and predefined colors corresponding to the Materials “Soil”, “Water” and “Tree”. Therefore, a colorful land-cover image (e.g., IMG103) is obtained from the satellite hyperspectral image (e.g., IMG101) by the provided method. For a further example, the provided Hyperspectral Image Unmixing (HIU) method is able to detect land-cover change via the satellite imageries. In other words, HIU can recognize different materials in an area. If two analysis result (e.g., two corresponding optimized fractional abundance matrices) at different time points are compared, the land-cover change can be identified easily.

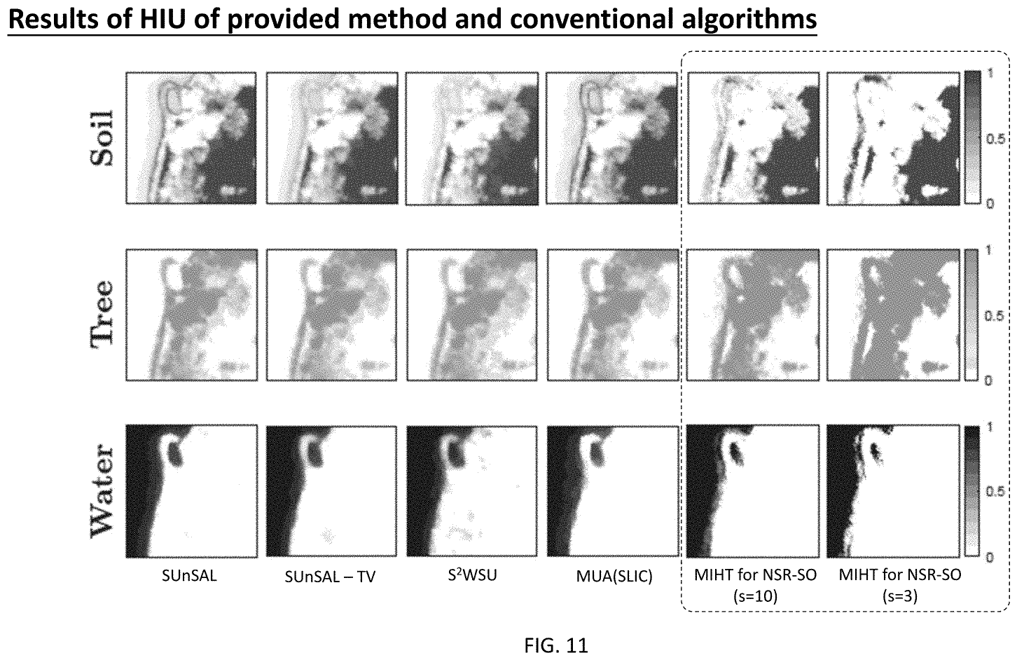

Referring to FIG. 11, the results (e.g., MIHT for NSR-SO (s=10) and MIHT for NSR-SO (s=3)) generated by provided method are compared with other conventional algorithms (e.g., SUnSAL, SUnSAL-TV, S²WSU, MUA(SLIC)). The areas of overlap regions of the materials in the HIU image generated by the provided method are much smaller than other conventional algorithms. Furthermore, in HIU of the provided method, the contours of different materials are more clear than other algorithms. In other words, the HIU of the provided method can provide more accurate detail about the shapes/regions of the identified materials.

The functional units of the methods and devices in accordance to embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices, including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in a distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method for simulating a market index by determining ratios of one or more component stocks of the market index by an analysis device, comprising:
receiving, by a processor of the analysis device, object data from a data source;
receiving, by the processor, control data from an input operation applied to the analysis device;
identifying, by the processor, one or more first values and one or more second values from the object data, and identifying a first parameter, a second parameter and a third parameter from the control data, wherein the first values are one or more index values of the market index within a period, the second values are prices of the component stocks corresponding to the index values, the first parameter is a set total number of the component stocks that are selected to track the market index, the second parameter is a set step-size in gradient descent, the third parameter is a set maximum total number of one or more optimization iterations;
inputting, by the processor, the first values, the second values, the first parameter, the second parameter and the third parameter into an executed analysis model; and
obtaining, by the processor, an optimized weight vector corresponding to the component stocks from the analysis model, so as to simulate the market index by the weight vector and the prices of the component stocks, wherein the weight vector comprising weight percentages respectively corresponding to the component stocks, and sum of the weight percentages is equal to one.

2. The method of claim 1, further comprising:
formulating, by an organizer of the analysis model, a linear regression optimization function according to the first values, the second values, the first parameter, the second parameter and the weight vector;
performing, by an optimizer of the analysis model, an optimization iteration according to the first values, the second values, the second parameter, the weight vector and the linear regression optimization function, so as to update the weight vector;
determining, by the optimizer, whether a stopping criterion corresponding to the third parameter is met;
if the stopping criterion corresponding to the third parameter is not met, determining, by the optimizer, whether the number of the performed optimization iterations reaches the third parameter; and
if the stopping criterion corresponding to the third parameter is met or if the number of the performed optimization iterations reaches the third parameter, outputting, by the optimizer, the current updated weight vector as the optimized weight vector.

3. The method of claim 2, wherein the step of performing the optimization iteration according to the first values, the second values, the second parameter, the weight vector and the linear regression optimization function to update the weight vector comprises:
calculating a first function according to the current weight vector, the first values and the second values;
calculating and updating an intermediate variable vector according to the first function, the current weight vector and the second parameter; and
updating the weight vector by calculating the linear regression optimization function of the updated intermediate variable vector.

4. The method of claim 3, wherein the first function is calculated by the equation below:
∇f(x^{t})=2A^{T}(Ax−y)
wherein ∇ƒ(x^{t}) is the first function, A are the second values, x is the current weight vector, y is the first values, and t is current iteration number.

5. The method of claim 3, wherein the intermediate variable vector is calculated by the equation below:
z^{t+1}=x^{t}−μ∇ƒ(x^{t})
wherein z^{t+1} is the updated intermediate variable vector, x is the current weight vector, μ is the second parameter, and t is current iteration number.

6. The method of claim 3, wherein the updated weight vector is calculated by the equation below:
x^{t+1}=P_{C}(z^{t+1})
wherein x^{t+1} is the updated weight vector, and P_{C}(z^{t+1}) is the projection optimization function of the updated intermediate variable vector, wherein P_{C}(z^{t+1}) is formulated as a projection optimization problem below:
$${min}_{x} {‖ {𝓏}^{t + 1} - x ‖}_{2}^{2} , \\ s . t . x \geq 0 , \\ {1}^{T} x = 1 , \\ {‖ x ‖}_{0} \leq S$$
wherein x≥0 denotes that the weight vector is nonnegative; x^{T}1=1 denotes that the sum of all entries of the weight vector is equal to one; S is the first parameter which is set as the desired number of the component stocks that are selected to tracking the market index.

7. A computer-implemented method for unmixing a hyperspectral image by determining a fractional abundance matrix corresponding to a spectral library by an analysis device, comprising:
receiving, by a processor of the analysis device, object data from a data source;
receiving, by the processor, control data from an input operation applied to the analysis server;
identifying, by the processor, a measured pixel spectrum of a hyperspectral image and a spectral library having one or more spectral signatures of one or more materials captured in the hyperspectral image from the object data, and identifying a first parameter, a second parameter and a third parameter from the control data, wherein the first parameter is a set total number of the materials in the hyperspectral image, the second parameter is a set step-size in gradient descent, the third parameter is a set maximum total number of optimization iterations;
inputting, by the processor, the measured pixel spectrum, the spectral library, the first parameter, the second parameter and the third parameter into an executed analysis model; and
obtaining, by the processor, a fractional abundance matrix corresponding to the spectral library, so as to simulate the hyperspectral image by the fractional abundance matrix and the spectral library, wherein the fractional abundance matrix comprising weight percentages respectively corresponding to spectral signatures of pixels in the hyperspectral image, and sum of the weight percentages is equal to one.

8. The method of claim 7, further comprising:
formulating, by an organizer of the analysis model, a first hyperspectral unmixing optimization function according to the measured pixel spectrum of the hyperspectral image, the spectral library, the first parameter, the second parameter and the fractional abundance matrix;
decomposing, by an optimizer of the analysis model, the fractional abundance matrix to one or more first column vectors, the measured pixel spectrum of the hyperspectral image to one or more second column vectors, and a first hyperspectral unmixing optimization function to a second hyperspectral unmixing optimization function, wherein the total number of the first column vectors and the total number of the second column vectors are the same;
performing, by the optimizer, an optimization iteration according a selected second column vector corresponding to a selected first column vector, the spectral library, the second parameter, the target first column vector and the second hyperspectral unmixing optimization function, so as to update the selected first column vector;
determining, by the optimizer, whether a stopping criterion corresponding to the third parameter is met;
if the stopping criterion corresponding to the third parameter is not met, determining, by the optimizer, whether the number of the performed optimization iterations reaches the third parameter;
if the stopping criterion corresponding to the third parameter is met or if the number of the performed optimization iterations reaches the third parameter, outputting, by the optimizer, the current updated selected first column vector as the optimized selected first column vector;
determining, by the optimizer, whether the first column vectors are all optimized;
if the first column vectors are not all optimized, selecting a unoptimized first column vector among the first column vectors; else
if the first column vectors are all optimized, composing, by the optimizer, all the optimized first column vectors as an optimized fractional abundance matrix.

9. The method of claim 8, wherein the step of performing the optimization iteration according the selected second column vector corresponding to the selected first column vector, the spectral library, the second parameter, the target first column vector and the second hyperspectral unmixing optimization function to update the selected first column vector comprises:
calculating a first function according to the selected first column vector, the selected second column vector and the spectral library;
calculating and updating an intermediate variable vector according to the first function, the selected first column vector and the second parameter; and
updating the selected first column vector by calculating the second hyperspectral unmixing optimization function of the updated intermediate variable vector.

10. The method of claim 9, wherein the first function is calculated by the equation below:
∇ƒ(x^{t})=2A^{T}(Ax−y)
wherein ∇ƒ(x^{t}) is the first function, A is the spectral library, x is the current selected first column vector, y is the selected second column vector, and t is current iteration number.

11. The method of claim 9, wherein the intermediate variable vector is calculated by the equation below:
z^{t+1}=x^{t}−∇ƒ(x^{t})
wherein z^{t+1} is the updated intermediate variable vector, x is the current selected first column vector, μ is the second parameter, and t is current iteration number.

12. The method of claim 9, wherein the updated selected first column vector is calculated by the equation below:
x^{t+1}=P_{C}(z^{t+1})
wherein x^{t+1} is the updated selected first column vector, and P_{C}(z^{t+1}) is the second hyperspectral unmixing optimization function of the updated intermediate variable vector, wherein P_{C}(z^{t+1}) is formulated as a projection optimization problem below:
$${min}_{x} {‖ {𝓏}^{t + 1} - x ‖}_{2}^{2} , \\ s . t . x \geq 0 , \\ {1}^{T} x = 1 , \\ {‖ x ‖}_{0} \leq S$$
wherein x≥0 denotes that the selected first column vector is nonnegative; x^{T}1=1 denotes that the sum of all entries of the selected first column vector is equal to one; Sis the set total number of the materials in the hyperspectral image.

13. An analysis device for simulating a market index by determining ratios of one or more component stocks of the market index, comprising:
a processor, configured to execute machine instructions to implement a computer-implemented method, the method comprising:
receiving, by the processor, object data from a data source;
receiving, by the processor, control data from an input operation applied to the analysis device;
identifying, by the processor, one or more first values and one or more second values from the object data, and identifying a first parameter, a second parameter and a third parameter from the control data, wherein the first values are one or more index values of the market index within a period, the second values are prices of the component stocks corresponding to the index values, the first parameter is a set total number of the component stocks that are selected to track the market index, the second parameter is a set step-size in gradient descent, the third parameter is a set maximum total number of one or more optimization iterations;
inputting, by the processor, the first values, the second values, the first parameter, the second parameter and the third parameter into an executed analysis model; and
obtaining, by the processor, an optimized weight vector corresponding to the component stocks from the analysis model, so as to simulate the market index by the weight vector and the prices of the component stocks, wherein the weight vector comprising weight percentages respectively corresponding to the component stocks, and the sum of the weight percentages is equal to one.

14. An analysis device for unmixing a hyperspectral image by determining a fractional abundance matrix corresponding to a spectral library, comprising:
a processor, configured to execute machine instructions to implement a computer-implemented method, the method comprising:
receiving, by a processor of the analysis device, object data from a data source;
receiving, by the processor, control data from an input operation applied to the analysis server;
identifying, by the processor, a measured pixel spectrum of a hyperspectral image and a spectral library having one or more spectral signatures of one or more materials captured in the hyperspectral image from the object data, and identifying a first parameter, a second parameter and a third parameter from the control data, wherein the first parameter is a set total number of the materials in the hyperspectral image, the second parameter is a set step-size in gradient descent, the third parameter is a set maximum total number of optimization iterations;
inputting, by the processor, the measured pixel spectrum, the spectral library, the first parameter, the second parameter and the third parameter into an executed analysis model; and
obtaining, by the processor, a fractional abundance matrix corresponding to the spectral library, so as to simulate the hyperspectral image by the fractional abundance matrix and the spectral library, wherein the fractional abundance matrix comprising weight percentages respectively corresponding to spectral signatures of pixels in the hyperspectral image, and the sum of the weight percentages is equal to one.
